(19) United States
(12) Patent Application Publication
(10) Pub. No.: US 2008/0273760 A1
(43) Pub. Date: Nov. 6, 2008

(54) METHOD AND APPARATUS FOR LIVESTOCK ASSESSMENT

(76) Inventors: Leonard METCALFE, Surrey (CA); Cornelis A.A.M. Maas, Heerlen (NL)

Correspondence Address: GLENN PATENT GROUP, 3475 EDISON WAY, SUITE L, MENLO PARK, CA, 94025, US

(21) Appl. No.: 11/744,672

(22) Filed: May 4, 2007

(51) Int. Cl. G06K 9/00

(52) U.S. Cl. 382/110

(57) ABSTRACT

A method and apparatus for capturing a three-dimensional representation of livestock involves simultaneously imaging the reflections of a light source from various portions of the animal on a two-dimensional pixel array and deriving range data for each pixel. The range data from the plurality of pixels is used to generate a three-dimensional representation of the animal for phenotype or other conformation assessments.

### FIELD OF THE INVENTION

This invention relates to the tracking, measurement and assessment of livestock. In particular, the invention relates to the tracking, measurement and assessment of livestock using machine vision technology.

### BACKGROUND OF THE INVENTION

The desirability of using machine vision to track the movement of livestock, and to assess their phenotype characteristics, body condition scores and conformation is well known. Such information is useful in a variety of specific applications, from husbandry to the slaughterhouse.

The most useful representation of the animal for many applications is a three-dimensional representation. Three-dimensional representations are particularly suited to assessing the body condition scores, muscle scores and conformation of livestock for breeding, feedlot, and grading and meat yield assessment purposes.

An overview of the use of machine vision technology in livestock data acquisition is offered in Kriesel, U.S. Patent Application Publication No. U.S. 2005/0136819, published Jun. 23, 2005. Kriesel's review includes a systematic breakdown of non-contact measurement approaches, including non-optical and optical methods. The considered approaches include measuring the silhouette or profile of the animal, visible spectrum video analysis techniques, stereoscopic systems including x-ray imaging, thermal imaging, and determining the size of laser spots reflected from the animal.

Kriesel also breaks down the various non-contact optical approaches between passive and active systems. Passive systems rely on ambient light and include passive stereo, shape from shading, shape from silhouette, passive depth from focus, and passive depth from defocus. Kriesel identifies active optical systems as those involving a controlled light source. Kriesel identifies some of the active optical approaches as being impractical, including a time of flight systems, interferometry, active depth from focus, active triangulation and active stereoscopic systems. Kriesel further discusses the relative merits of different three-dimensional imaging technologies as applied to livestock.

The prevailing approach to obtaining three-dimensional images is to provide a number of cameras offering different points of view from various locations around a stall and processing the resulting images to derive a three-dimensional representation of the animal. A number of sometimes sophisticated algorithms and approaches have been used to derive the 3-D representations from essentially two-dimensional images. A representative example (the use of stereo matching) is provided in Tielett et al.'s work entitled “Extracting Morphological Date From 3D Images of Pigs”, R. D. Tillett, N. J. B. McFarlane, J. Wu, C. P. Schofield, X. Ju, J. P. Siebert, Agriculture Engineering (AgEng2004) Conference, Leuven, pp. 203-222, Belgium, 12-16 Sep., 2004.

The difficulties inherent in using several cameras and the desirability of minimizing the number of cameras are also known. Apart from the complexity of deriving aggregate data in a useful form, the more cameras are involved, the greater the processing time that is required to capture and process images.

It is an object of the present invention to provide an efficient method and apparatus for tracking, assessing and measuring livestock that overcomes these limitations.

More particularly, it is an object of this invention to provide a means of securing three-dimensional images of livestock using machine vision technology in an efficient and simple way.

Other objects of the invention will be appreciated by reference to the disclosure and claims that follow.

### SUMMARY OF THE INVENTION

In the past few years, there have become available active pixel sensing cameras comprising two-dimensional pixel arrays wherein the time of flight of a single pulse of light reflected off an object can be assessed individually for each pixel of the array. Other systems, also commonly referred to as “time of flight”, actually assess the phase delay in the emitted and reflected forms of modulated light.

This “time of flight” assessment capability, when applied in a machine vision context, gives rise to the possibility of providing pixel by pixel range information based on time of flight data. Using suitable optics to image different portions of an animal on different pixels, the ranges calculated from each pixel results in a set of three-dimensional data and hence a depth map representation of the animal (from the point of view of the camera). The use of such a system can support volumetric and conformation assessment of livestock using even a single camera, for example a camera mounted overhead.

Such an approach offers the possibility of significantly faster processing than has been available in the prior art as a single simultaneous illumination of the visible parts of the animal is all that is required to generate a three-dimensional representation of the animal. The use of a plurality of such cameras offering views from different sides or angles still offers significant advantages over the prior art in terms of reduced computational complexity and reduced processing time.

In one aspect the invention comprises a method of securing a three-dimensional representation of a livestock animal. The field of view that encompasses the animal is simultaneously illuminated and a single overall image is captured on a two-dimensional pixel array. For each pixel of the array, a measurement is taken to derive the distance from the pixel to the portion of the animal imaged on that pixel. This may be done, for example, by assessing-the phase delay in the case of modulated light or by assessing the actual time of flight in the case of a pulse of light. Range values are collected for each pixel and a three-dimensional representation of the animal is then constructed from the collection of range values from the various pixels of the array.

In another aspect, the intensity of the light received at each pixel is also evaluated and used to derive the three-dimensional representation.

In a more particular aspect, the light source is modulated and the distance is determined by assessing the phase delay between the emitted light and the light reflected to each pixel. Another approach involves determining the distance by direct assessment of the time of flight of a pulse of light emitted to simultaneously illuminate the entire field of view, to each pixel of the array.

In another aspect, such approaches are used to determine a body condition score of the animal using the three-dimensional representation.

In yet a further aspect, the invention comprises a system for assessing a livestock animal. An imaging unit mounted for viewing a livestock measurement zone comprises a two-dimensional pixel array. The imaging unit is adapted to derive data for each pixel in relation to a light reflected to the imaging unit from the animal. A light source is provided for generating the light so as to simultaneously illuminate the measurement zone. A processor calculates range values from the data for each pixel. A processor is used to derive a three-dimensional representation of at least a portion of the animal and a processor is used to derive from the three-dimensional representation an assessment of a feature of the animal.

The foregoing was intended as a broad summary only and of only some of the aspects of the invention. It was not intended to define the limits or requirements of the invention. Other aspects of the invention will be appreciated by reference to the detailed description of the preferred embodiment and to the claims.

### BRIEF DESCRIPTION OF THE DRAWINGS

The preferred embodiment of the invention will be described by reference to the detailed description thereof in conjunction with the drawing in which:

FIG. 1 is a perspective view of the preferred embodiment of the invention imaging a dairy cow in a measurement zone;

FIG. 2 is a diagram of a camera used in the preferred embodiment and an associated outboard processor;

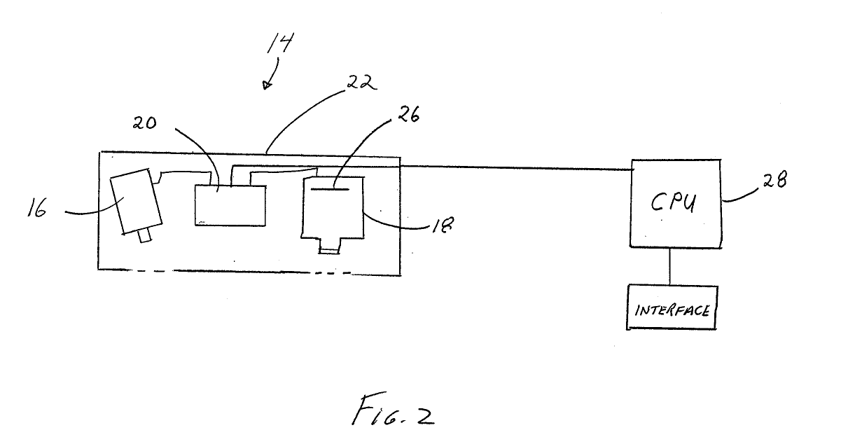

FIG. 3 is a diagram of an image on a two dimensional array according to the preferred embodiment; and,

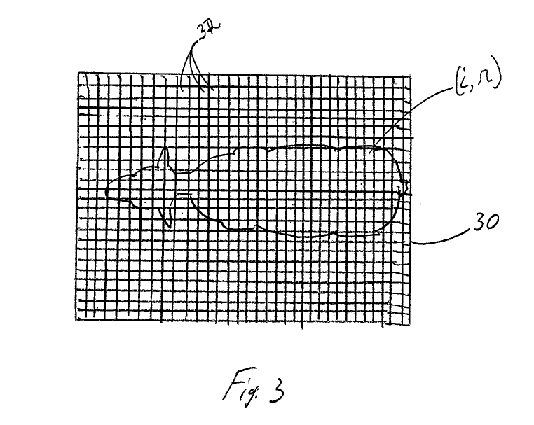

FIG. 4 is a perspective view of an alternative embodiment of the invention using two cameras.

### DETAILED DESCRIPTION OF THE PREFERRED EMBODIMENT

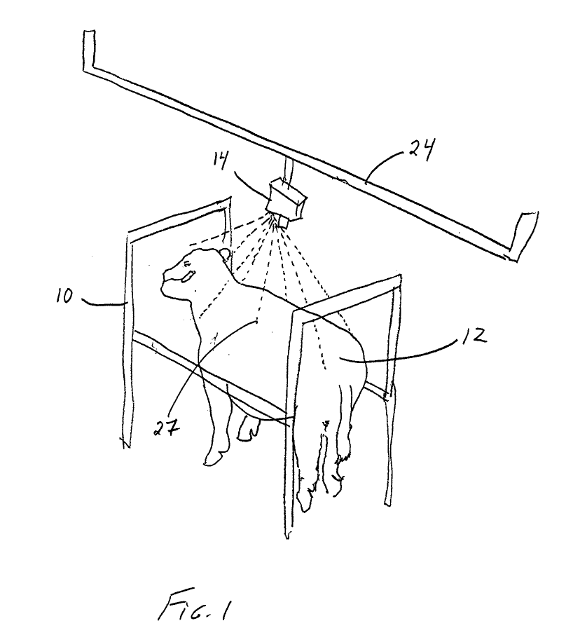

Referring to FIG. 1, a lane, gate or stall 10 defines a target measurement zone in which livestock 12 (for example, a dairy cow or a hog) is to be imaged.

A camera package 14 comprising a two-dimensional array camera 18, a light source 16 and processing electronics 20 is enclosed within a housing 22. The housing 22 is mounted on a frame 24 so as to be suspended for a plan view of the measurement zone. The measurement zone corresponds to the field of view of two-dimensional array camera 18.

Light source 16 comprises an array of LEDs that emit a continuously modulated infra-red periodic waveform so as to simultaneously illuminate substantially the whole of the field of view.

Camera 18 has the capability of assessing the phase delay between the emitted light and the light reflected from the reflection surface 27, for each pixel of two dimensional array 26. Phase delay data is used to derive the range from each pixel to the reflection surface 27. In the preferred embodiment, camera 18 consists of the SR-3000 camera stack developed by CSEM S.A. The SR-3000 is an all solid-state system that provides 176×144 pixels and a field of view of 47.5 to 39.6 degrees. The stack includes a pulsed IR LED array that generates a continuously modulated sine wave at 850 nm. The camera is shuttered to provide a frame rate of about 50 frames per second.

Both intensity and phase data is collected and outputted as x, y, z data for each pixel. Appropriate adjustments are made using lookup tables for calibrating the output for temperature, LED output variations and other biases.

An outboard central processor 28 is provided to process the data into an intensity and range/depth map 30 of the animal, with each pixel 32 providing quantitative intensity (i) and range (r) information for the part of the animal imaged by that pixel. The outboard processing includes normalization, black level subtraction and the transformation of the phase data to spherical, then Cartesian, coordinates.

In the preferred embodiment, the curvature of the spine and the profile of the tailbone region of a dairy cow are used by processor 28 to also calculate a body condition score for the animal, using the intensity and depth map and morphological assessment algorithms.

In an alternative embodiment, the light source 16 radiates a single pulse of light over the whole of the field of view. A high speed counter is associated with each pixel and the count continues until reflected light photons are detected by that pixel. The count data then provides a direct correspondence to time of flight data for each pixel. Such a system is disclosed in Bamji, U.S. Pat. No. 6,323,942. The time of flight data for each of the pixels is then combined to generate a three-dimensional map of the field of view.

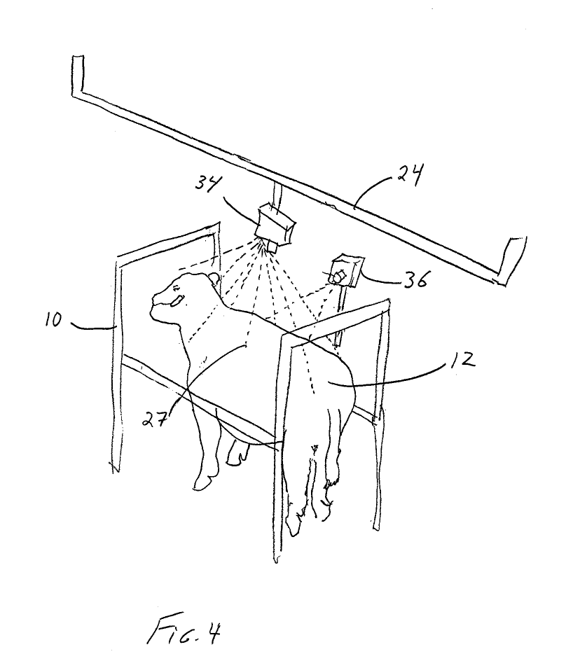

The invention is not limited to the use of a single camera. In FIG. 4, an overhead camera 34 is twinned with a side view camera 36. The combined output of the two cameras is collated into a three-dimensional representation of the animal. If pulses of light are used, the pulses generated by the two cameras are lo synchronized so as to be non-overlapping.

It will be appreciated by those skilled in the art that the preferred and alternative embodiments have been: described in some detail but that certain modifications may be practiced without departing from the principles of the invention.

1. A method of securing a three-dimensional representation of a livestock animal in a field of view comprising:
simultaneously illuminating substantially the whole of said field of view with light;
imaging said simultaneously illuminated field of view on a two-dimensional pixel array and for each pixel of said array, determining the distance traveled by the reflection of said light from a portion of said animal to said pixel to provide a range value in relation to said pixel;
deriving a three-dimensional representation of at least a portion of said animal from a plurality of said range values.

2. The method of claim 1 further comprising:
for each pixel of said array, measuring an intensity value in relation to a portion of said light that is reflected from said animal to said pixel; and,
deriving a three-dimensional representation of said animal from a plurality of said range values and a plurality of said intensities.

3. The method of claim 1 wherein:
said light is modulated; and,
said step of determining the distance comprises assessing the phase delay between the light emitted to illuminate said field of view and the light reflected to said pixel.

4. The method of claim 1 wherein:
said step of simultaneously illuminating comprises emitting a pulse of light; and,
said step of determining the distance comprises assessing the time of flight of said pulse to said pixel.

5. A method of assessing a livestock animal comprising:
for each pixel of a two dimensional pixel array, deriving time of flight data for light reflected from a portion of said animal and deriving a range value from said time of flight data;
deriving a three-dimensional representation of at least a portion of said animal from a plurality of said range values; and,
assessing a body condition score of said animal using said three-dimensional representation.

6. The method of claim 5 wherein said light is modulated light.

7. The method of claim 5 wherein said light is a pulse of light.

8. A system for assessing a livestock animal comprising:
a livestock measurement zone;
an imaging unit mounted for viewing said livestock measurement zone;
said imaging unit comprising a two-dimensional pixel array and adapted to derive data for each pixel in relation to a light reflected to said imaging unit from said animal;
a light source for generating said light so as to simultaneously illuminate said measurement zone;
a processor for calculating range values from said data for each pixel;
a processor for deriving a three-dimensional representation of at least a portion of said animal; and,
a processor for deriving from said three-dimensional representation an assessment of a feature of said animal.
